(19) United States
(12) Patent Application Publication
(10) Pub. No.: US 2013/0138857 A1
(43) Pub. Date: May 30, 2013

(54) Extensive Battery management system

(71) Applicants: Fa-Hwa Shieh, Taoyuan County (TW); Ming-Lun Liu, Taoyuan County (TW); Wen-Chen Lih, Taoyuan County (TW); Chee-Chang Chen, Taoyuan County (TW)

(72) Inventors: Fa-Hwa Shieh, Taoyuan County (TW); Ming-Lun Liu, Taoyuan County (TW); Wen-Chen Lih, Taoyuan County (TW); Chee-Chang Chen, Taoyuan County (TW)

(73) Assignee: Chung-Shan Institute of Science and Technology, Armaments, Bureau, Ministry of National Defense, Taoyuan County (TW)

(21) Appl. No.: 13/304,740

(22) Filed: Nov. 28, 2011

(51) Int. Cl. G06F 13/14

(52) U.S. Cl. 710/305

(57) ABSTRACT

Disclosed is an extensive battery management system for a second-used application automobile use batteries. The extensive battery management system includes a process unit, a record unit, an input interface and an output interface. The record unit is connected to the process unit so that the former stores data from the latter. The input interface is connected to the process unit. The output interface is connected to the process unit.

### BACKGROUND OF INVENTION

1. Field of Invention

The present invention relates to a second-used application for automobile use batteries and, more particularly, to an extensive battery management system for a second-used application for automobile use batteries.

2. Related Prior Art

An electric vehicle such as an electric bus, an electric car and an electric scooter includes a automobile use batteries including at least one battery and a battery management system (“BMS”). After some time of use, the actual capacity of the battery eventually gets too low to drive the electric vehicle, e.g., only 70% or less of the nominal capacity/power of the battery. The actual capacity/power of the used automobile use batteries is however still good enough for use in a grid or an urgent power system (“UPS”) for example. Such use is called second-used application. The second-used application extends the life of the automobile use batteries and therefore reduces the cost of the purchase of the automobile use batteries.

The BMS of automobile use only provides information about the voltage, temperature, current and state of charge (“SOC”). The BMS is in communication of data with a hardware interface according to a predetermined protocol to take measures for protecting the battery.

In the second-used application of many used automobile use batteries, the used automobile use batteries may be made of different models by different manufacturers and the protocols for the communication of the data may be different. Hence, there is a need for a collective control mechanism for controlling the SOC of the used automobile use batteries for stability and security. It is however a heavy burden on the collective control mechanism to handle the communication of the data through the different protocols.

Moreover, the states of charge of the used automobile use batteries are not as good as new ones and must be under tougher monitor and control.

Furthermore, when the automobile use batteries are used in the vehicles, the batteries only provide high power transiently, and the battery management systems only monitor the batteries transiently. The battery management systems do not always record the voltages, temperatures and currents of the batteries all the time. Such constant record is however necessary for the second-used application of the used automobile use batteries. Such constant record is essential for the evaluation of the used automobile use batteries if they are to be rented or sold.

Furthermore, it is more difficult and hence extensive to dismantle the used automobile use batteries to replace the used battery management systems with a new battery management system than connect the used batteries to a new battery management system.

The present invention is therefore intended to obviate or at least alleviate the problems encountered in prior art.

### SUMMARY OF INVENTION

It is the primary objective of the present invention to provide an extensive battery management system for a second-used application automobile use batteries.

To achieve the foregoing objective, the extensive battery management system includes a process unit, a record unit, an input interface and an output interface. The record unit is connected to the process unit so that the former stores data from the latter. The input interface is connected to the process unit. The output interface is connected to the process unit.

In an aspect, the process unit is a processor, microcontroller unit, a digital signal processor, a programmable logic controller, a logic circuit, a microcomputer or a computer.

In another aspect, the record unit is a flash memory, a portable storage medium, a memory card and a hard disc drive.

In another aspect, the input interface is RS232, RS485, an inter-integrated circuit bus, a controller area network bus, a local interconnect network bus, a FlexRay bus, a system management bus, serial peripheral interface, USB or IEEE1394.

In another aspect, the input interface can be connected to a built-in battery management system of a second-used application automobile use batteries.

In another aspect, the output interface is Bluetooth protocol, short range wireless protocol, wireless personal area network protocol, IEEE 802.11 protocol, IEEE 802.15 protocol, IEEE 802.16 protocol and wireless local area network protocol or wireless fidelity protocol.

In an alternative aspect, the output interface is a wire with an interface such as a controller area network bus, a local interconnect network bus, a FlexRay bus, a system management bus or Ethernet.

In another aspect, the output interface is used for hand-shake with a collective control mechanism.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of an extensive battery management system according to the preferred embodiment of the present invention;

FIG. 2 is a block diagram of a automobile use batteries managed by the extensive battery management system shown in FIG. 1; and

FIG. 3 is a block diagram of two automobile use batteries managed by two extensive battery management systems as the one shown in FIG. 1.

### DETAILED DESCRIPTION OF PREFERRED EMBODIMENT

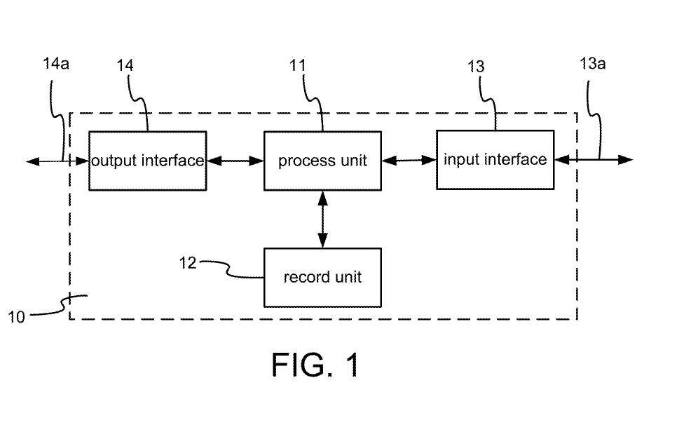

Referring to FIG. 1, shown is an extensive battery management system 10 according to the preferred embodiment of the present invention. The extensive battery management system 10 includes at least one process unit 11, at least one record unit 12, at least one input interface 13 and at least one output interface 14.

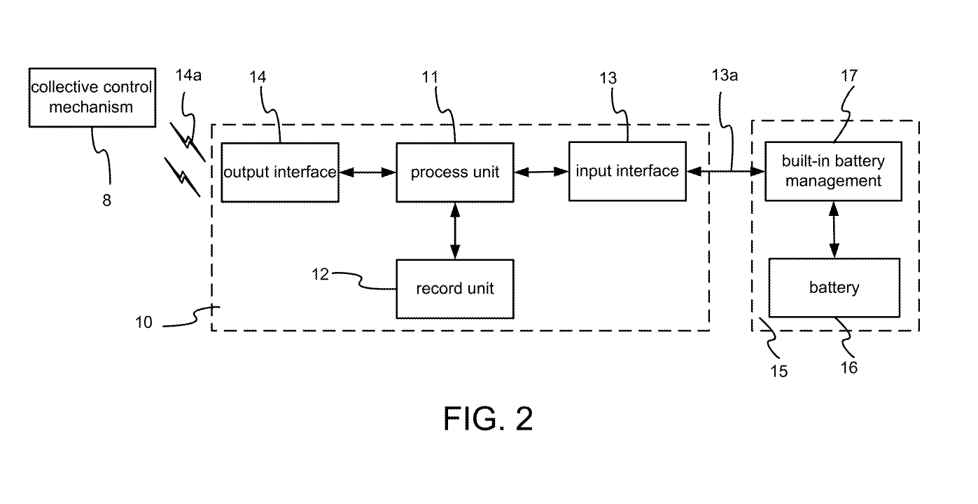

Referring to FIG. 2, a second-used application automobile use batteries 15 is managed by the extensive battery management system 10. The second-used application power storage 15 includes at least one battery 16 and a built-in battery management system 17.

The process unit 11 may be a processor, a microcontroller unit (“MCU”), a digital signal processor (“DSP”), a programmable logic controller (“PLC”), a logic circuit, a microcomputer or a computer.

The record unit 12 is connected to the process unit 11 and used to store data that have been processed by the process unit 11. The record unit 12 may be a flash memory, a portable storage medium, a memory card or a hard disc drive.

The input interface 13 is connected to the process unit 11. The input interface 13 is made in compliance with a communication interface and path 13a required by the built-in battery management system 17 of the second-used application automobile use batteries 15. The input interface 13 may be RS232, RS485, an inter-integrated circuit (“I2C”) bus, a controller area network (“CAN”) bus, local interconnect network (“LIN”) bus, a FlexRay bus, a system management (“SM”) bus, serial peripheral interface (“SPI”), USB, IEEE1394 or any other proper interface.

The output interface 14 is connected to the process unit 11. The output interface 14 is made in compliance with a communication interface and path 14a required by a collective control mechanism 8. The output interface 14 may be Bluetooth, short range wireless protocol, wireless personal area network (“WPAN”) protocol, IEEE 802.11 protocol, IEEE 802.15 protocol, IEEE 802.16 protocol, wireless local area network (“WLAN”) protocol or wireless fidelity (“Wi-Fi”) protocol. Alternatively, the output interface 14a may be a wire such as a CAN bus, an LIN bus, a FlexRay bus, a SM bus, Ethernet or any other proper interface.

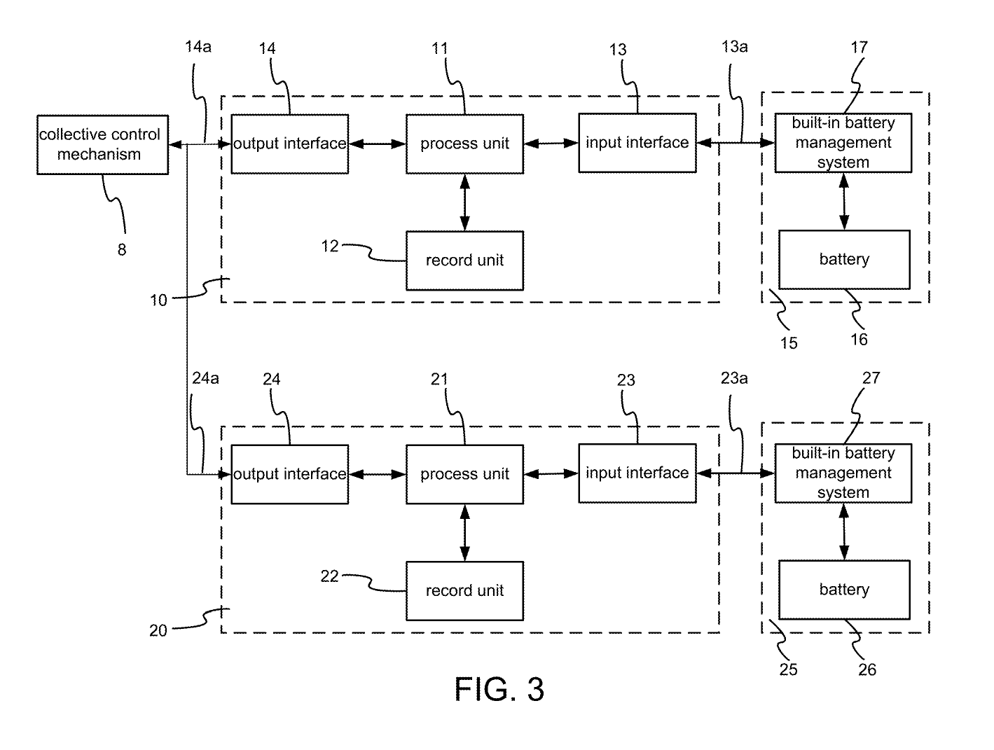

Referring to FIG. 3, two second-used application automobile use batteries 15 and 25 are managed by two extensive battery management systems 10 and 20. It should be noted that a proper number of second-used application automobile use batteries can be managed by an identical number of extensive battery management systems.

The second-used application automobile use batteries 25 includes at least one battery 26 and a built-in battery management system 27. The extensive battery management system 20 includes at least one process unit 21, at least one record unit 22, at least one input interface 23 and at least one output interface 24.

The built-in battery management system 17 of the second-used application automobile use batteries 15 is connected to the input interface 13 of the extensive battery management system 10. The built-in battery management system 27 of the second-used application automobile use batteries 25 is connected to the input interface 23 of the extensive battery management system 20.

The second-used application automobile use batteries 15 may be removed from an electric bus. The built-in battery management system 17 may communicate through a FlexRay bus. Accordingly, the input interface 13 of the extensive battery management system 10 may be a FlexRay bus, and the path 13a may be a wire.

The second-used application automobile use batteries 25 may be removed from an electric car. The built-in battery management system 27 may communicate through a CAN bus. Accordingly, the input interface 23 of the extensive battery management system 20 may be a CAN bus and the path 23a may be a wire.

The process unit 11 receives information about the transient voltage, temperature and current or any other proper information in the battery 16 of the second-used application automobile use batteries 15 through the input interface 13 and stores the information in the record unit 12. The process unit 21 receives information about the transient voltage, temperature and current or any other proper information in the battery 26 of the second-used application automobile use batteries 25 through the input interface 23 and stores the information in the record unit 22.

If necessary, the collective control mechanism 8 is used for hand-shake with the output interfaces 14 and 24 and for receiving the information about the batteries 16 and 26 from the record units 12 and 22 through the process units 11 and 21.

Where the record units 12 and 22 are portable storage media, they can be detached and read.

The interface required by the collective control mechanism 8 may be Ethernet. The path may be a wire. Information about the highest voltage, the lowest voltage, the highest temperature, the lowest temperature, transient current, the state of charge and the security of the batteries 16 and 26 is to be transmitted. Accordingly, the information required by the collective control mechanism 8 is processed by the process units 11 and 21 and transmitted to the collective control mechanism 8 through the output interfaces 14 and 24 according to Ethernet and along paths 14a and 24a.

The information about the second-used application automobile use batteries 15 and 25 is processed by the process units 11 and 21 in compliance with the requirements of the collective control mechanism 8. Hence, the second-used application automobile use batteries 15 and 25 are compatible because of the extensive battery management systems 10 and 20. Moreover, the collective control mechanism 8 instantly controls and the extensive battery management systems 10 and 20 instantly record battery status parameters individually.

As discussed above, the built-in battery management systems 17 and 27 of the second-used application automobile use batteries 15 and 25 are reserved and the extensive battery management systems 10 and 20 are devised in compliance with the interface and protocol required by the collective control mechanism 8 for storing the voltage, temperature, current and state of charge in the batteries 16 and 26. Thus, the cost of the use of the second-used application automobile use batteries 15 and 25 is reduced.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An extensive battery management system including:
a process unit 11;
a record unit 12 connected to the process unit 11 for storing data from the process unit 11;
an input interface 13 connected to the process unit 11; and
an output interface 14 connected to the process unit 11.

2. The extensive battery management system according to claim 1, wherein the process unit is selected from the group consisting of a processor, microcontroller unit, a digital signal processor, a programmable logic controller, a logic circuit, a microcomputer and a computer.

3. The extensive battery management system according to claim 1, wherein the record unit is selected from the group consisting of a flash memory, a portable storage medium, a memory card and a hard disc drive.

4. The extensive battery management system according to claim 1, wherein the input interface is selected from the group consisting of RS232, RS485, an inter-integrated circuit bus, a controller area network bus, a local interconnect network bus, a FlexRay bus, a system management bus, serial peripheral interface, USB and IEEE1394.

5. The extensive battery management system according to claim 1, wherein the input interface can be connected to a built-in battery management system of a second-used application automobile use batteries.

6. The extensive battery management system according to claim 1, wherein the output interface is selected from the group consisting of Bluetooth protocol, short-range wireless protocol, wireless personal area network protocol, IEEE 802.11 protocol, IEEE 802.15 protocol, IEEE 802.16 protocol and wireless local area network protocol and wireless fidelity protocol.

7. The extensive battery management system according to claim 1, wherein the output interface is a wire with an interface selected from the group consisting of a controller area network bus, a local interconnect network bus, a FlexRay bus, a system management bus and Ethernet.

8. The extensive battery management system according to claim 1, wherein the output interface is used for hand-shake with a collective control mechanism.
